(19) United States
(12) Patent Application Publication
(10) Pub. No.: US 2024/0409851 A1
(43) Pub. Date: Dec. 12, 2024

(54) FILMS AND CAPSULES

(71) Applicant: Conopco Inc., d/b/a UNILEVER, Englewood Cliffs, NJ (US)

(72) Inventors: Luc-Sebastian Jarzynski, Wageningen (NL); Maria Fernanda Jimenez Solomon, Wageningen (NL); Andrew Philip Parker, Wageningen (NL)

(73) Assignee: Conopco Inc., d/b/a UNILEVER, Englewood Cliffs, NJ (US)

(21) Appl. No.: 18/700,272

(22) PCT Filed: Oct. 19, 2022
(86) PCT No.: PCT/EP2022/079086

§ 371 Date: Apr. 11, 2024

(30) Foreign Application Priority Data
Oct. 25, 2021 (EP) 21204419.2

(51) Int. Cl. C11D 17/04; C08J 5/18; C11D 3/30

(52) U.S. Cl. CPC C11D 17/042; C08J 5/18; C11D 3/30; C08J 2389/00

(57) ABSTRACT

A water-soluble film comprising a protein e.g. casein or derivative and a bittering agent and a unit dose product comprising a substrate treatment formulation within a sealed package, the package comprising the film.

The present invention relates to a renewable water soluble film for substrate treatment compositions.

Despite the prior art there remains a need for renewable films with safety features whilst still having processability using with standard unit dose processing technology i.e. thermoforming.

WO2014026856 and WO2014026855 disclose water-soluble packaging containing a bittering agent e.g. Bitrex®. In these patents, suitable water-soluble films are disclosed marketed by MonoSol LLC, for example under the designation M8630, C8400 or M8900. Other suitable films include films named Solublon® PT, Solublon® GA, Solublon® KC or Solublon® KL from Aicello Chemical Europe GmbH or the films VF-HP from Kuraray.

Accordingly, and in a first aspect, there is provided a water-soluble film comprising a protein and a bittering agent.

The applicant has surprisingly found that bittering agents can be incorporated into protein films and water-soluble packaging made from such films with improved processability permitting forming a sealable pouch using standard unit dose processing technology. Such films may be used for formation of secondary packaging such as soft wrap packaging, or, more preferably in the formation of water-soluble pouches for unit dose applications.

The following terms, as used here are defined below:

“A” and “an”, are understood to mean one or more of what is claimed or described.

“Alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbonyl, carbonyloxy, cyano, methylsulfonylamino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

“Biodegradable” means the complete breakdown of a substance by microorganisms to carbon dioxide water biomass, and inorganic materials.

“Film” refers to a water soluble material and may be sheet-like material. The length and width of the material may far exceed the thickness of the material, however the film may be of any thickness.

“petrochemical” refers to an organic compound derived from petroleum, natural gas, or coal.

“Polymer” refers to a macromolecule comprising repeat units where the macromolecule has a molecular weight of at least 1000 Daltons. The polymer may be a homopolymer, copolymer, terpoymer etc.

“Product” means any construction that is suitable for containing a substrate treatment composition as defined herein. The product is preferably a water-soluble package but can be in any form, such as open or fully enclosed container, film packaging, film pockets, capsules, and containers.

“Renewable” refers to a material that can be produced or is derivable from a natural source which is periodically (e.g., annually or perennially) replenished through the actions of plants of terrestrial, aquatic or oceanic ecosystems (e.g., agricultural crops, edible and non-edible grasses, forest products, seaweed, or algae), or microorganisms (e.g., bacteria, fungi, or yeast).

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

“Substrate” mean any suitable substrate including fabric articles or garments, bedding, towels etc., and dishes, where “dishes” is used herein in a generic sense, and encompasses essentially any items which may be found in a dishwashing load, including crockery chinaware, glassware, plasticware, hollowware and cutlery, including silverware.

“Thermoforming” means a process in which the film is deformed by heat, and in particular it may involve the following: a first sheet of film is subjected to a moulding process to form an enclosure in the film e.g. forming a recess in the film. Preferably this involves heating prior to deformation. The deformation step is preferably enabled by laying the film over a cavity and applying a vacuum or an under pressure inside the cavity (to hold the film in the cavity). The recesses may then be filled. The process may then include overlaying a second sheet over the filled recesses and sealing it to the first sheet of film around the edges of the recesses to form a flat sealing web, thus forming a capsule which may be a unit dose product. The second film may be thermoformed during manufacture. Alternatively the second film may not be thermoformed during manufacture. Preferably, the first water-soluble film is thermoformed during manufacture of the unit dose article and the second water-soluble film is not thermoformed during manufacture of the unit dose article.

“Substrate treatment composition” means any type of treatment composition for which it is desirable to provide a dose thereof in a water-soluble and is designed for treating a substrate as defined herein. Such compositions may include, but are not limited to, laundry cleaning compositions, fabric softening compositions, fabric enhancing compositions, fabric freshening compositions, laundry prewashing compositions, laundry pretreating compositions, laundry additives (e.g., rinse additives, wash additives, etc.), post-rinse fabric treatment compositions, dry cleaning compositions, ironing aid, dish washing compositions, hard surface cleaning compositions, and other suitable compositions that may be apparent to one skilled in the art in view of the teachings herein.

“surfactant” or “surface active agent” refers to an organic chemical that when added to a liquid changes the properties of that liquid at a surface.

“Unit dose” means an amount of composition suitable to treat one load of laundry, such as, for example, from about 0.05 g to about 100 g, or from 10 g to about 60 g, or from about 20 g to about 40 g. A unit dose product may be in the form of a film package containing the composition, the package may be referred to as a capsule or pouch.

“Water-soluble” means the article (film or package) dissolves in water at 20° C.

Unless otherwise noted, all component or composition levels are in reference to the active portion of that component or composition, and are exclusive of impurities, for example, residual solvents or by-products, which may be present in commercially available sources of such components or compositions.

Except in the examples and comparative experiments, or where otherwise explicitly indicated, all numbers are to be understood as modified by the word “about”.

All percentages (expressed as “%”) and ratios contained herein are calculated by weight unless otherwise indicated. All conditions herein are at 20° C. and under the atmospheric pressure, unless otherwise specifically stated. All polymer molecular weights are determined by weight average number molecular weight unless otherwise specifically noted.

Numerical ranges expressed in the format “from x to y” are understood to include x and y. When for a specific feature multiple preferred ranges are described in the format “from x to y”, it is understood that all ranges combining the different endpoints are also contemplated. In specifying any range of values or amounts, any particular upper value or amount can be associated with any particular lower value or amount.

The protein may be an animal e.g. casein or caseinate or whey protein.

Preferably the protein excludes gelatine or derivatives thereof.

Preferably the protein is a vegetable protein including globular proteins such as protein from pulses, tofu, soya, tempeh, seitan, nuts, seeds, grains. Pulses are a large group of plants, which include chickpeas, lentils, beans (such as black, kidney and adzuki beans) and split peas.

Preferably the protein is a plant protein.

Plant protein examples include wheat gluten, corn zein, soy protein, and mung bean protein

Preferably any soy protein comprises a globular soy protein, more preferably β-Conglicinin (7S) and/or Glycinin (11S).

The protein may comprise a combination of any of the above-mentioned proteins.

The protein may be a phosphoprotein. Preferably the protein comprises casein or derivatives thereof. The casein may be present as a caseinate such as a metal salt e.g. sodium or calcium caseinate.

### PVOH

The film may comprise polyvinyl alcohol (PVOH). The PVOH may be present at a maximum level of 50% wt, preferably at maximum of 25%, (% wt based on total dry (cast) weight of the film).

Advantageously the film is substantially free of polyvinyl alcohol (PVOH) and more preferably less than 5% wt, even more preferably less than 1% wt and most preferably 0% wt, by weight of the composition.

### Bittering Agent

Preferably the film comprises a bittering agent. Preferably this is selected from: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

Preferred bittering agents include pungents such as capsaicinoids, which includes capsaicin, dihydrocapsaicin, nordihydrocapsaicin, homodihydrocapsaicin, homocapsaicin, and nonivamide. Other pungents which can act as bittering agents include pungents, piperine, allyl isothiocyanate, and resinferatoxin). A particularly preferred bittering agent is capsaicin.

Bittering agents may also be selected from denatonium salts such as denatonium benzoate, denatonium saccharide, denatonium chloride benzoic benzylamine amide, trichloroanisole, methyl anthranilate and quinine (and salts of quinine).

Further examples of bittering agents include flavonoids such as quercefin and naringin, sucrose octaacetate, quassinoids such as quassin and brucine, and agents derived from plant or vegetable matter, such as chemical compounds derived from chilli pepper plants, those derived from a plant species of the genus cynaro, alkaloids and amino acids. Preferably, the bittering agent is selected from the group consisting of denatonium benzoate, denatonium saccharide, quinine or a salt of quinine. The chemical name of denatonium is phenylmethyl-[2-[(2,6-dimethylphenyl)amino]-2-oxoethyl]-diethylammonium. In particular embodiments, the bittering agent is denatonium benzoate or denatonium saccharide.

The bittering agent may be incorporated within the film or in a film-coating on the exterior surface of the film (prior to making the capsule) or water-soluble capsule. Preferably the bittering agent is incorporated into the film.

The bittering agent may be incorporated into the matrix of a water-soluble polymer included in the film by dissolving the bittering agent in a water-soluble polymer solution before the unprinted region of the film is formed. The bittering agent may be present in film material in a range of 100 to 5000 ppm, preferably 200 to 3000 ppm, more preferably 500 to 2000 ppm, based on the weights of the bittering agent and film. For example, 1 mg of bittering agent may be incorporated into 1 g of film to provide the bittering agent at 1000 ppm.

Additionally or alternatively, the bitter agent may be included in the water-soluble package as a powdered bittering agent in a powder coating applied to the exterior surface of the water-soluble package (described in more detail below)

Preferably, the water-soluble package includes a powder coating on an exterior surface of the film, and the powder coating includes a powdered lubricating agent. The powder coating, when present, may coat printed region or regions and/or unprinted region or regions (if present) of the film. In any printed regions of the film, the powder coating may be indirectly on the exterior surface of the film where there is a layer of dye or pigment. The powder coating may be applied to least 50%, preferably at least 60%, at least 70% even more preferably at least 80%, most preferably at least 90% percent by area of the exterior surface of the film. The powder coating can be applied by any known technique such as spray-coating or passing the film through a falling curtain of powder coating composition. The powder coating may be applied to the exterior surface of the film at a rate of 0.5 to 10 mg per 100 cm², in some embodiments not more than 5 mg per 100 cm², and in further embodiments in the range of 1.25 to 2.5 mg per 100 cm². The powder coating may be applied to or present on the exterior surface of the film in an amount of 100 ppm or more, preferably 200 ppm or more, more preferably 300 ppm or more, based on the weights of the powder coating and the film. For example, a 1 mg of powder coating may be applied to a 1 g film to provide a 1000 ppm coating on the substrate. In certain embodiments, the powder coating is applied to or present on the exterior surface of the film in a range of 100 to 5000 ppm, preferably 200 to 3000 ppm, more preferably 300 to 2000 ppm.

### Lubricating Agent

The powder coating may include a powdered lubricating agent. Typical powdered lubricating agents include oligosaccharide, polysaccharide and inorganic lubricating agents. The powdered coating may include one or more of the group selected from starch, modified starches (including, but limited to, corn starch, potato starch or hydroxyethyl starch) silicas, siloxanes, calcium carbonate, magnesium carbonate, clay, talc, silicic acid, kaolin, gypsum, zeolites, cyclodextrans, calcium stearate, zinc stearate, alumina, magnesium stearate, sodium sulphate, sodium citrate, sodium tripolyphosphate, potassium sulphate, potassium citrate, potassium tripolyphosphate and zinc oxide. In a preferred embodiment, the powdered lubricating agent includes talc.

The powder coating can include a bittering agent in addition to or as an alternative to a bittering agent being present within or film-coated on the film. The powdered bittering agent may be a powdered form of any one of the bittering agents described herein. When a bittering agent is included in a powder coating, the powdered bittering agent may form 5 weight percent or more of the powder coating based on the total weight of the powder coating. In some embodiments, the powdered bittering agent forms 10 weight percent or more, 15 weight percent or more, 20 weight percent or more, or 25 weight percent or more of powder coating based on the total weight of the powder coating. In some embodiments, the powdered bittering agent forms 75 weight percent or less, 70 weight percent or less, 65 weight percent or less, 60 weight percent or less, or 55 weight percent or less of the powder coating based on the total weight of the powder coating. In further embodiments, the powdered bittering agent forms 5 to 75 weight percent, 10 to 70 weight percent, 15 to 65 weight percent, 20 to 60 weight percent, or 25 to 55 weight percent of the powder coating based on the total weight of the powder coating. In alternative embodiments, the powdered bittering agent forms 50 weight percent or less, 40 weight percent or less, 30 weight percent or less of the powder coating based on the total weight of the powder coating. In these embodiments, it is advantageous to include a relatively low amount of powdered bittering agent in the powder coating while maintaining a bitter taste when a user tries to ingest the water-soluble package.

The powdered bittering agent, when present, may have an average particle diameter of at least about 0.1 microns. The powdered bittering agent may have an average particle diameter of about 200 microns or less. In some embodiments, the powdered bittering agent has an average particle diameter of in the range of about 0.1 to 100 microns, in other embodiments in the range of about 0.1 to 20 microns and in further embodiments in a range of about 5 and 15 microns. Average particle diameter can be measured by known optical imaging techniques.

In some embodiments, the powder coating further includes one or more additional active agents. The additional active agent may be selected from one or more of the group of enzymes, oils, odour absorbers, fragrances, bleaches, bleach components, cleaning polymers, soil release polymers, EPEI, water softeners, dyes and fabric softeners.

### Additives

The water-soluble film can contain other auxiliary agents and processing agents, such as, but not limited to, plasticizers, plasticizer compatibilizers, surfactants, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfite or others), and other functional ingredients, in amounts suitable for their intended purposes. Embodiments including plasticizers are preferred. In embodiments, the water-soluble film includes a surfactant, an antioxidant, a bittering agent, a soil release polymer, an anti-redeposition aid, a chelant, a builder, a perfume, or combinations thereof. The amount of auxiliary agents can be up to about 50 wt. %, 20 wt %, 15 wt %, 10 wt %, 5 wt. %, 4 wt % and/or at least 0.01 wt. %, 0.1 wt %, 1 wt %, or 5 wt %, individually or collectively.

Preferably the film may further include a plasticizing surfactant which may be anionic, cationic, nonionic or amphoteric.

The most preferred surfactant is a nonionic.

Nonionic surfactants for use in the invention include polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

Examples of alcohol ethoxlates include Ziegler-synthesized alcohol alkoxylate, an oxo-synthesized alcohol alkoxylate, Guerbet alcohol alkoxylates, alkyl phenol alcohol alkoxylates or a mixture thereof.

Examples of alcohol ethoxylates include fatty alcohol ethoxylates of formula R₂—(OCH2CH2)y-OH, where R₂ is a linear or branched fatty alcohol.

Fatty alcohol ethoxylates described may not be single compounds as suggested by the formula R₂—(OCH2CH2)y-OH, but rather comprise a mixture of several homologs having varied polyalkylene oxide chain length and molecular weight. For example, fatty alcohol ethoxylate derived from conventional potassium hydroxide-catalyzed ethoxylation of the alcohol with 1, 2, and 3 moles of ethylene oxide, respectively, is not a single compound containing 1, 2, or 3 (CH2CH2O) units as the formula may suggest. Instead, the fatty alcohol ethoxylate is a mixture of several homologs whose total ethylene oxide units vary from 0 to 10. It is understood, therefore, that fatty alcohol ethoxylate may comprise some non-ethoxylated (unreacted) fatty alcohol.

The nonionic surfactant may comprise one or more than one type of fatty alcohol ethoxylate; the different types of fatty alcohol ethoxylates may differ in carbon chain length and/or degree of ethoxylation. The compositions disclosed herein may comprise a mixture of fatty alcohol ethoxylates, where the mixture may have an average (arithmetic mean) carbon chain length within the range of 12 to 16 carbon atoms, or an average carbon chain length of 12 carbon atoms.

The nonionic surfactant may comprise a methyl ester ethoxylate.

Non-ethoxylated alcohol nonionic surfactants include alkylpolyglycosides, glycerol monoethers, and polyhydroxyamides (glucamide), glycereth cocoate or mixtures thereof.

Another suitable type of nonionic surfactant useful herein comprises the amine oxide surfactants. Amine oxides are materials which are often referred to in the art as “semi-polar” nonionics. Amine oxides have the formula:

R(EO)x(PO)y(BO)zN(O)(CH2R′)2·qH2O.

In this formula, R is a relatively long-chain hydrocarbyl moiety which can be saturated or unsaturated, linear or branched, and can contain from 8 to 20, 10 to 16 carbon atoms, or is a C12-C16 primary alkyl. R′ is a short-chain moiety, in one aspect R′ may be selected from hydrogen, methyl and —CH2OH. When x+y+z is different from 0, EO is ethyleneoxy, PO is propyleneneoxy and BO is butyleneoxy. Amine oxide surfactants are illustrated by C12-14 alkyldimethyl amine oxide.

The nonionic surfactants for use in the invention include alkylpolysaccharides, such as alkyl poly glycosides or derivatives therefrom.

The nonionic surfactant may be a sugar-based surfactant selected from alkyl polyglycosides as above described, or sorbitan esters, sucrose esters, and fatty acid glucamides.

Where the nonionic surfactant comprises a sorbitan ester, this may comprise at least one ethoxylated fatty acid sorbitan ester with general formula (II):

Sorb-(EOₙ₁R₁)(EOₙ₂R₂)(EOₙ₃R₃)(EOₙ₄R₄) (II)

in which:

Sorb represents a residue obtained by removing four hydroxyl H atoms from sorbitan; EO represents an ethyleneoxy group; R₁, R₂, R₃ and R₄ are each independently selected from H or a —C(O)R₅ group in which R₅ is selected from straight or branched chain monovalent hydrocarbyl radicals having from 8 to 22 carbon atoms and mixtures thereof (provided that at least one of R₁ to R₄ is —C(O)R₅); n₁, n₂, n₃ and n₄ each independently represent average values from 0 to 10. Preferably the total [n₁+n₂+n₃+n₄] has an average value from 4 to 30 preferably from 5-25.

Sorbitan is a generic name for anhydrides derived from sorbitol, a naturally occurring crystalline hexahydric alcohol found in fruits, seaweed, and algae. In formula (II) above, the residue ‘Sorb’ is obtained by removing four hydroxyl H atoms from sorbitan, and will typically be a mixture of residues of 1,4-anhydrosorbitol, 1,5-anhydrosorbitol, and 3,6-anhydrosorbitol. The ethoxylated fatty acid ester is formed by each of the removed H atoms being substituted with the groups (EOₙ₁R₁), (EOₙ₂R₂), (EOₙ₃R₃), and (EOₙ₄R₄). Preferably, one of R₁ to R₄ is —C(O)R₅ and the remaining 3 are hydrogen. However, esters with more than one —C(O)R₅ group (e.g. diesters and triesters) will also usually be present in the products as synthesised. Thus the products will often have non-integral ratios of Sorb and R₅ residues as defined in formula (II). For example, an average of 1.4 to 1.5 of the R₁, to R₄ groups may be —C(O)R₅ and the remaining 2.5 to 2.6 hydrogen.

The individual oligoethoxylate chain lengths corresponding to the individual indices n₁, n₂, n₃ and n₄ in formula (II) are preferably each within the range from 0.5 to 6 and more preferably from 1 to 5. As the indices represent average values for the oligoethoxylate chain lengths, they may individually and in total be non-integral. The total [n₁+N₂+n₃+n₄] in formula (II) preferably has an average value (an “average ethoxylation value” as used herein, from 15 to 25, more preferably from 18 to 22 and most preferably 20. Higher ethoxylation values can reduce cleaning efficiency due to increased hydrophilicity and lower ethoxylation values reduce cleaning efficiency as the molecule becomes less soluble.

R₅ in formula (II) is preferably selected from linear or branched, alkyl or alkenyl groups having from 10 to 20 carbon atoms and 0 or 1 double bond. More preferably, R₅ in formula (II) is selected from linear alkyl or linear alkenyl groups containing from 12 to 18 carbon atoms and 0 or 1 double bond, such as lauryl, myristyl, palmityl, cetyl, oleyl and stearyl and mixtures thereof. Most preferably, R₅ in formula (II) is selected from oleyl, stearyl and lauryl and mixtures thereof (as may for example be derived from natural fats and/or optionally hydrogenated natural oils such as palm oil, soybean oil, rapeseed oil, sunflower oil and tallow).

Examples of suitable ethoxylated fatty acid sorbitan esters (ii) for use in the invention include polyoxyethylene (20) sorbitan monolaurate, polyoxyethylene (20) sorbitan monopalmitate, polyoxyethylene (20) sorbitan monostearate, polyoxyethylene (20) sorbitan monooleate and mixtures thereof.

Non-limiting examples of nonionic surfactants include: a) C12-C18 alkyl ethoxylates, such as, NEODOL® nonionic surfactants from Shell; b) C6-C12 alkyl phenol alkoxylates wherein the alkoxylate units are a mixture of ethyleneoxy and propyleneoxy units; c) C12-C18 alcohol and C6-C12 alkyl phenol condensates with ethylene oxide/propylene oxide block polymers such as Pluronic® from BASF; d) C14-C22 mid-chain branched alcohols, BA, as discussed in U.S. Pat. No. 6,150,322; e) C14-C22 mid-chain branched alkyl alkoxylates, BAEx, wherein x if from 1-30, as discussed in U.S. Pat. Nos. 6,153,577, 6,020,303 and 6,093,856; f) Alkylpolysaccharides as discussed in U.S. Pat. No. 4,565,647 to Llenado, issued Jan. 26, 1986; specifically alkylpolyglycosides as discussed in U.S. Pat. Nos. 4,483,780 and 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

The films and capsules of the invention may include further surfactants in addition to nonionic surfactants as defined herein such as anionic surfactants, amphoteric (zwitterionic) and/or cationic surfactants. Mixtures of any of the above described materials may also be used. However, it may be preferable in some cases that the level of such further surfactants is no more than 0.1%, more preferably from 0 to 0.01% and most preferably 0% (by weight based on the total weight of the composition). Most preferably only nonionic surfactants are present in the film.

The film preferably also contains one or more further or co-plasticizers. Such co-plasticizers include, but are not limited to polyols, poly-alcohols, or sugar alcohols and may be selected from glycerol, poly glycerol, diglycerin, hydroxypropyl glycerine, ethylene glycol, diethylene glycol, triethylene glycol, tetraethylene glycol, monopropylene glycol, propylene glycol, polyethylene glycol, neopentyl glycol, trimethylpropane polyether polyols, sorbitol, manninol, ethanolamines and mixtures thereof.

The protein e.g. casein may be present at any suitable level e.g. from 1-99% wt. Preferably, the protein e.g. casein is present at from 40% wt of the film, more preferably from 50% wt of the film, even more preferably from 60% wt. of the film.

Preferably the protein e.g. casein is present at no more than 90% wt of the film, more preferably no more than 80% wt. of the film, most preferably no more than 70% wt.

Suitable protein e.g. casein amounts are selected from the range of 40 to 90% wt., more preferably 50 to 80% wt.

The surfactant may be present at any suitable level e.g. from 1 to 60% wt. of the film. Preferably the surfactant is present at from 5% wt of the film, more preferably from 10% wt. of the film, more preferably from 20% wt. of the film.

Preferably the surfactant is present at no more than 50% wt. of the film, more preferably at no more than 40% of the film.

The further plasticiser may be present at any suitable level e.g. from 1 to 50%. Preferably the co-plasticiser is present at from 10% wt. of the film more preferably from 20% wt of the film.

Preferably the further plasticiser is present at no more than 40% wt. of the film, more preferably at no more than 30% wt. of the film.

Preferably the film comprises 60-80% protein e.g. casein, 10-30% co-plasticiser and 5-15% surfactant.

The surfactant and the further plasticiser may be present in equal amounts. A particularly preferred embodiment is a film having protein e.g. casein, further plasticiser and surfactant in the ratio 7:2:1 (protein e.g. casein:co-plasticiser:surfactant)

### Film Thickness

The film e.g. capsule film may have a thickness (before incorporation into a product e.g. capsule) from 40 to 200 micrometres (microns), preferably from 40 to 150 micrometres (microns), more preferably from 40 to 100 micrometres (microns), even more preferably from 60 to 90 micrometres (microns), most preferably from 70 to 80 micrometres (microns).

In embodiments, the film may have a thickness (before incorporation into a product e.g. capsule) from 151-200 micrometre, preferably from 160-200, more preferably from 170-200 micrometre.

Water-soluble capsules may be made using two films, e.g one (second) film superposed over another (first) film and sealed around edge regions e.g. as described herein. Where two films are used to make a capsule, the second film is typically of a similar type to that used for the first film, but slightly thinner. Thus, in embodiments, the second film is thinner than the first film. In embodiments the ratio of thickness of the first film to the thickness of the second film is from 1:1 to 2:1.

In embodiments the first film thickness (pre-thermoforming) is from 40 to 200 micrometres, from 40 to 150 micrometres, from 60 to 120 micrometres, or from 80 to 100 micrometres. After capsule manufacture generally the average thickness of the first film will be from 30 to 90 micrometres, or from 40 to 80 micrometres.

In embodiments the second film thickness (pre-thermoforming) is from 20 to 100 micrometres, from 25 to 80 micrometres, or from 30 to 60 micrometres.

### Layer

Preferably the film comprises a single layer, that is to say it comprises no more than one layer. One way this may be achieved is that the film is made by forming a solution of carrageenan with a solvent e.g. water and any other ingredients (plasticisers, bittering agent as examples) and this is then cast e.g. poured on to a surface such as a moving belt and then dried. No further layers of the film are added by casting.

from 60 microns to 90 microns, most preferably between 70 microns and 80 microns.

The film may be made into a unit dose product.

In a second aspect there is provided a unit dose substrate product comprising a substrate treatment formulation within a sealed container, said container comprising a film according to the first aspect of the invention and any preferred/optional features as described herein.

Packages comprising a film such as those described herein may be manufactured using a form fill seal approach or using a vacuum form, fill seal approach. Pouches may be formed on a continuously moving process where a film is drawn into a mould, filled from above and then sealed by application of a second film. The pouches are then separated from one another to form individual unit dose products.

Substrate treatment capsules e.g. laundry capsules maybe thermoformed which involves a moulding process to deform sheet film to provide recesses therein. The process involves heating sheet film to soften and deform the film to stretch and fill a cavity in a mould and also the application of vacuum. The recesses are filled and the capsules completed by overlaying a second sheet of film over the filled recesses and sealing it to the first sheet of film around the edges of the recesse to form a flat seal. Relaxation of the first film typically then causes the applied second sheet to bulge out when the vacuum is released from the first sheet of film in the mould. For high performance laundry or machine dish wash treatment capsules there is a need to fill the capsule with sufficient liquid. The fill volume results in a greater stretch imposed on the water-soluble and provides a capsule with a bulbous, convex outer profile as the first and second sheets bulge out and stretch under the pressure. Films need to be strong and sufficiently stretchy to allow for this process. Films according to the invention are advantageous for thermoforming such capsules as they exhibit strength and stretch.

The two films may be heat or water sealed depending on the process machinery used.

In a second aspect there is provided a unit dose substrate product comprising a substrate treatment formulation within a sealed container, said container comprising a film according to any preceding claim.

The water soluble packages of the present invention can be manufactured using standard known techniques. For example, a sheet of film (e.g. film) may be printed with one or more layers of dye or pigment in a pattern. The pattern may be indicia, such as words, symbols or drawings.

The layer or layers of dye or pigment may be printed onto the film using an ink. The ink type is not particularly limited, and includes non-aqueous solvent-based inks (such as organic solvent-based inks), aqueous-based inks and/or UV cured inks. In some embodiments, the ink is a non-aqueous-based ink.

The film may be printed with a primer layer before printing of the layer or layers of dye or pigment. After printing with the layer or layers of dye or pigment, the film may be printed with a protective or lacquer layer. The printed layer or layers may be then dried, for example using heat and/or air flow. The resulting printed film may be stored, transported or used immediately to form the printed water-soluble packages as described herein.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either side of the film.

When the bittering agent is contained within at least part of the film, the bittering agent is typically present in the film before printing. In one embodiment, the bittering agent is included at least on part of the exterior surface of the film as a film coating. The film coating of bittering agent may be deposited on the water-substrate before, during or after the printing of the printed regions.

The printed film is typically formed (preferably thermoformed) into a film enclosure (e.g. a film pocket, open capsule or container). The film enclosure may then be filled with a composition such as a dishwashing or laundry detergent composition. The water-soluble enclosure containing the composition or material can then be sealed, for example by sealing the edges of the enclosure or joining the enclosure with one or more additional pieces of film, in order to enclose the material or composition in the printed water-soluble package. The powder coating may then be applied to the exterior surface of the film. The powder coating may be applied to the film by any known powder technique. Preferably, the powder is applied to the film using no solvent or a non-aqueous solvent. Such an application reduces the risk of dissolving the film. The above optional and preferred features are equally combinable and applicable to all aspects of the invention, unless indicated otherwise.

In a particular embodiment, the present invention provides a printed water-soluble package comprising a film of the first aspect, the film enclosing a composition, the film having an exterior surface with one or more printed regions, the bittering agent is selected from the group consisting of denatonium benzoate, denatonium saccharide, quinine or a salt of quinine and is substantially homogenously contained within the film, and wherein the water-soluble package further includes a powder coating coated on the exterior surface of the film, the powder coating a including a powdered lubricating agent, the powdered lubricating agent being talc.

### Liquid Laundry Detergent Composition

The substrate composition may be in the form of a solid, a liquid, a dispersion, a gel, a paste, a fluid or a mixture thereof. The capsule preferably comprises a liquid composition.

Non-limiting examples of compositions include cleaning compositions, fabric care compositions, automatic dishwashing compositions and hard surface cleaners. More particularly, the compositions may be a laundry, fabric care or dish washing composition including, pre-treatment or soaking compositions and other rinse additive compositions. The laundry detergent composition may be used during the main wash process or could be used as pre-treatment or soaking compositions.

The water-soluble capsule preferably comprises a laundry detergent composition. The liquid composition may be opaque, transparent or translucent.

The or each compartment may comprise the same or a different composition, however, it may also comprise different compositions in different compartments. The composition may be any suitable composition.

Laundry detergent compositions include fabric detergents, fabric softeners, 2-in-1 detergent and softening, pre-treatment compositions and the like. Laundry detergent compositions may comprise surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an ingredient selected from the group comprising a shading dye, surfactant, polymers, perfumes, encapsulated perfume materials, structurant and mixtures thereof.

The liquid laundry detergent composition may comprise an ingredient selected from, bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylates, structurant and mixtures thereof.

Surfactants can be selected from anionic, cationic, zwitterionic, non-ionic, amphoteric or mixtures thereof. Preferably, the fabric care composition comprises anionic, non-ionic or mixtures thereof.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹ (CₘH₂ₘO)ₙOH wherein R¹ is a C₈-C₁₆ alkyl group, m is from 2 to 4, and n ranges from about 2 to 12. In one aspect, R₁ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain on average from about 2 to 12 ethylene oxide moieties per molecule, or from about 3 to 10 ethylene oxide moieties per molecule.

The shading dyes employed in the present laundry detergent compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred. The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The laundry detergent compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1 percent to about 50 percent or even from about 0.1 percent to about 25 percent bleaching agent by weight of the subject cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1 percent by weight of the compositions herein to about 15 percent, or even from about 3.0 percent to about 15 percent by weight of the compositions herein.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001 percent, from about 0.01 percent, from about 0.05 percent by weight of the cleaning compositions to about 10 percent, about 2 percent, or even about 1 percent by weight of the cleaning compositions.

The laundry detergent composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS−DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose. Another suitable cellulosic polymer is cationically modified hydroxyethyl cellulose. Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Suitable suds suppressors include silicone and/or fatty acid such as stearic acid. The liquid laundry detergent composition maybe coloured. The colour of the liquid laundry detergent composition may be the same or different to any printed area on the film of the article. Each compartment of the unit dose article may have a different colour. Preferably, the liquid laundry detergent composition comprises a non-substantive dye having an average degree of alkoxylation of at least 16.

At least one compartment of the unit dose article may comprise a solid. If present, the solid may be present at a concentration of at least 5 percent by weight of the unit dose article.

The second water-soluble film may comprise at least one open or closed compartment. In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches are cut to produce individual unit dose articles.

Those skilled in the art would recognize the appropriate size of mould needed in order to make a unit dose article according to the present invention.

When carrying or containing a substrate treatment composition, this may be a laundry treatment composition such as a laundry liquid or powder composition. Such formulations are well known in the art and comprise water up to around 15% wt. of the composition; surfactants such as anionic surfactants, non-ionic surfactants, zwitterionic surfactants and mixtures thereof. Further, polymeric cleaning aids such as soil release polymers and polyamines are commonly employed to improve cleaning performance. Fragrances are added for providing a fragrance benefit to the fabric after treatment.

Visual cues such as dyes are used to provide improved aesthetics.

### Combinations of Aspects

A number of proposals and aspects are described herein, which proposals and aspects are intended to be combined to achieve improved or cumulative benefits. Thus, any one aspect may be combined with any other aspect. Similarly the optional features associated with any one of the aspects may apply to any one of the other aspects.

### EXAMPLES

### Example 1: Exemplary Films were Made with Varying Ratios of Casein, Surfactants (Suganate) and Glycerol as in the Table 1 Below

### Materials

Protein: Calcium caseinate powder (CaCas) or Sodium caseinate powder (NaCas)
Glycerol (95%)

### Surfactants:

Suganate type “100NC” is Suga®Nate 100NC, available from Colonial Chemical, Inc., located in South Pittsburgh, TN (CAS NUMBER 742087-48-5).
Bitrex® (Denatonium Benzoate) when used, it was used as granules at a level of 1000 ppm of Bitrex™ in the dry film.

### Ratios

### 6:4 NaCas

Solids percentage in solution=25%, the ratio of NaCas to glycerol is 6:4. For 100 g of film solution we have 15 g of NaCas, 10 g of glycerol, and 75 g of water

### 7:2:1 NaCas

Solids percentage in solution=22%, the correct ratio of NaCas to glycerol and suganate 100NC is 6:4. For 100 g of film solution we have 15 g of NaCas, 5 g of glycerol, 2 g of pure suganate and 78 g of water
6.8:2.3:0.9, which is approximately a ratio of 7:2:1

### Example 2 Method for Making the Casein Film Compositions of Example 1

### Preparation of Polymer Solutions to Cast Films of Table 1

1. Sodium caseinate/glycerol (NaCas/Gly) and Na casein/glycerol/suganate (NaCas/Gly/100NC) film-making solutions were prepared with deionized (DI) water to a total solids concentration of 25% (w/w). Solution compositions were calculated to keep a constant 6:4 NaCas:Gly ratio.
2. Casein was dissolved in boiling DI water with overhead stirrer (added gradually) then left for approx. 5-10 minutes.
3. The solution was mechanically stirred at 500 rpm for approximately 20 minutes until full dissolution and mixing, ensuring the stirrer was fully immersed to avoid formation of bubbles. Once the caseinate was dissolved, glyercine/surfactant/^{Bitrex™} were added as specified
4. The mixture was then centrifuged for 100 minutes at 6000 rpm to degas and remove bubbles.

### Casting

1. Films were cast on to a polyacrylate substrate using a Elcometer 4340 Motorised/Automatic Film Applicator and Elcometer 3570 Micrometric Film Applicators.
2. The casting knife was set at different thickness (for clarity this is the thickness of the cast solution or wet film, before the film has set and water evaporated from the solution).
3. The optimum speed was 700 μm and film thicknesses were varied.
4. Casting speed 3 (1.2 m per minute) was used and this advantageously reduces bubbles.
5. Any bubbles observed can be popped e.g. with a sharp spatula.
6. The films were dried in ambient laboratory conditions for 12-48 hours (the time depends on ambient conditions) and then tested for peeling from the substrate. For increased drying speed, films can be dried in an oven at 40° C. for 2 hours.

### Example 3: Ultimate Stress and Strain Analysis

### Method of Measuring Strain and Stress.

Film samples of varying thickness were subjected to tensile: stress and strain tests using an Instron model 5566. For these tensile studies, strain is the elongation before break and the stress is the force applied before break. We used a 100N load cell on film strips 12 cm×2.5 cm, following ASTM D882 and we use a speed rate of maximum 8 mm per second. This method is a standard test method for analysing the tensile characteristics of thin plastic sheeting. In this test, the plastic sheet is pulled until it breaks for measuring the elongation, tensile yield strength, tensile modulus, and tensile strength at break, and is specifically designed for films of less than 1 mm in thickness.

Ultimate strain gives an indication of how much a film can stretch. For certain products, such as formed capsules, sheet film needs to stretch/deform so it can form a 3-D shape. For a rounded, hemispherical deformation the film needs to stretch by about 40% (to a total of 140%). Such a recess allows sufficient (for performance) levels of substrate composition. However, the film must also be sufficiently strong not to break as it stretches. Therefore ultimate stress is also important, to ensure the strength of a film (under tension). At the same time, the film must not be too thick as this can slow down dissolution. Both strength and stretch in a thin film are needed for a film to be a viable manufacturing material.
NaCas 6:4 films are very sticky compared to 7:2:1.

### Film Ultimate Strain and Stress Test Results

### Instron:

### Ultimate Tensile Strain (%):

| | | | | | | | Average | |
|---|---|---|---|---|---|---|---|---|
| | | | | | | | Strain | |
| Film | Thickness | 1 | 2 | 3 | 4 | 5 | (%) | SD |
| Na Cas | 100 um | 75.408 | 71.124 | 85.204 | 58.863 | 54.669 | 69.053 | 11.101 |
| 7:2:1 | | | | | | | | |
| Na Cas | 100 um | 97.760 | 49.991 | 80.134 | 63.427 | 63.528 | 70.968 | 16.456 |
| 7:2:1 + | | | | | | | | |
| bitrex | | | | | | | | |
| Na Cas | 140 um | 69.07 | 72.376 | 68.56 | 49.097 | 67.140 | 65.249 | 8.256 |
| 6:4 | | | | | | | | |
| Na Cas | 140 um | 70.54 | 83.22 | 86.75 | 85.22 | 67.71 | 78.69 | 7.94 |
| 6:4 + | | | | | | | | |
| bitrex | | | | | | | | |

The above data shows that for each casein film, the addition of bitrex improves the strain result.

### Ultimate Tensile Stress (MPa):

| | | | | | | | Average | |
|---|---|---|---|---|---|---|---|---|
| | | | | | | | stress | |
| Film | Thickness | 1 | 2 | 3 | 4 | 5 | (MPa) | SD |
| Na Cas | 100 um | 13.04 | 13.32 | 11.96 | 13.76 | 13.76 | 13.169 | 0.662 |
| 7:2:1 | | | | | | | | |
| Na Cas | 100 um | 10.69 | 10.8 | 11.8 | 12.667 | 11.8 | 11.55 | 0.731 |
| 7:2:1 + | | | | | | | | |
| bitrex | | | | | | | | |
| Na Cas | 140 um | 4.64 | 4.826 | 4.828 | 4.54 | 4.71 | 4.71 | 0.110 |
| 6:4 | | | | | | | | |
| Na Cas | 140 um | 4.77 | 4.54 | 4.24 | 4.54 | 4.83 | 4.59 | 0.21 |
| 6:4 + | | | | | | | | |
| bitrex | | | | | | | | |

The above data shows that for each casein film, the addition of bitrex improves the stress result.

### Example 4 Film Dissolution Tests

Film pieces were cut to the size 4 cm×2.5 cm and weight 0.09 g were dissolved in 150 mL of demineralised water at 20° C. and 40° C. in a 250 ml beaker stirring at 150 rpm and recorded time until total film dissolution.

| | | | | | | Average | |
|---|---|---|---|---|---|---|---|
| Film | Thickness | 1 | 2 | 3 | 4 | Time (s) | SD |
| Na Cas | 110 um | 75 | 72 | 75 | 77 | 74.75 | 1.78535711 |
| 7:2:1 | | | | | | | |
| Na Cas | 110 um | 129 | 126 | 123 | 119 | 124.25 | 3.69966215 |
| 7:2:1 + | | | | | | | |
| Bitrex ® | | | | | | | |
| Na Cas | 120 um | 91 | 89 | 96 | 95 | 92.75 | 2.86138079 |
| 6:4 | | | | | | | |
| Na Cas | 120 um | 102 | 118 | 105 | 100 | 106.25 | 7.01338007 |
| 6:4 + | | | | | | | |
| Bitrex ® | | | | | | | |

All films, including the Bitrex® impregnated films dissolve under 3 mins.

### Test Carried Out at 40 C, Film Weight˜0.12 g

| | | | | | | | | Average | |
|---|---|---|---|---|---|---|---|---|---|
| Film | Thickness | 1 | 2 | 3 | 4 | 5 | 6 | Time (s) | SD |
| Na Cas | 100 um | 100 | 103 | 101 | Not tested | | | 101.3333 | 1.247219 |
| 7:2:1 | | | | | | | | | |
| Na Cas | 100 um | 47 | 65 | 55 | Not tested | | | 55.66667 | 7.363574 |
| 7:2:1 + | | | | | | | | | |
| bitrex | | | | | | | | | |
| Na Cas | 140 um | 42 | 72 | 119 | Not tested | | | 77.66667 | 31.68947 |
| 6:4 | | | | | | | | | |
| Na Cas | 0.12 g | 187 | 157 | 67 | 217 | 258 | 172 | 176.3333 | 58.85481 |
| 6:4 + | (varied | | | | | | | | |
| bitrex | thickness) | | | | | | | | |

All films, including the Bitrex® impregnated films dissolve under 3 mins and in the case of the surfactant containing film, the Bitrex® reduced the dissolution time.

### Example 5: Method of Making the Capsules Containing a Substrate Treatment Formulation

Two sheets of the film were prepared as described above. The sheets can be sealed around the edges (except for one edge) to form an open package, the package filled with a substrate treatment composition, and then the edge sealed. This forms a simple pillow-shaped package.

In another method, the capsule is produced by a process of thermoforming:
(a) the first sheet of film comprising protein as above is placed over a mould having a cavity;
(b) the cavity is heated and also a vacuum applied to the film to mould the film into the cavities and hold it in place to form a corresponding recess in the film;
(c) the recess is then filled with a substrate treatment composition;
(d) the second sheet of film is superposed over the first sheet of film across the formed recess and sealed around the edge to produce a capsule having a compartment bounded by a continuous seal (referred to as a sealing web);
(e) the capsule is trimmed to remove excess sheet.

Relaxation of the first film typically then causes the applied second sheet to bulge out when the vacuum is released from the first sheet of film in the mould. Where multiple capsules are made from a single sheet (which may be fed from a roll) the film is cut between the capsules so that a series of capsules are formed.

Sealing can be done by any suitable method for example heat-sealing, solvent sealing or UV sealing or ultra-sound sealing or any combination thereof. Particularly preferred is water-sealing. Water sealing may be carried out by applying water/moisture to the second sheet of film before it is sealed to the first sheet of film to form the seal areas.

### Example 6 Liquid Capsules Dissolution Tests

Capsules are made according to the example, filled with a commercially available laundry detergent composition. The capsules are tested for dissolution.
1. Add 4.5 litres of water (demin) into a 5-litre beaker
2. Heat up the water to 30° C.
3. Place the beaker on the magnetic stirrer plate and add a large magnetic stirrer
4. Turn on the magnetic stirrer so that the vortex is 3 cm in depth
5. Place the capsule in the centre of the open holed net, gather the net up above the capsule and fasten with an elastic band (the capsule is held in a net to simulate the capsule being held in-between fabrics and it allows the water to flow through the net)
6. Clamp the stirrer paddle with the capsule in a net attached above the beaker
7. Lower the net into the water up to the mark indicated on the paddle and start the clock immediately
8. Time how long it takes for the capsule to dissolve by noting the following: Bubble from liquid, Liquid leaking time, Liquid gone, film dissolved.

All capsules dissolve in the range 30 s-30 mins releasing the formulation into the water.

### Example 7

Bitrex impregnated films as described above are printed with a UV-curable ink, and the thin film is UV-cured. Capsules are made as described above using this film and then filled with two different commercially available laundry detergent compositions. The capsules are loaded into standard laundry detergent capsule containers.

The containers are placed in storage at a range of climatic conditions: 20° C. & 65% relative humidity (RH); 28° C. & 70% RH; and 37° C. & 70% RH. Such conditions simulate west European ambient conditions and accelerated testing. The capsules are assessed visually at various time points.

### Example 8 Soy Protein Films

### Soy Protein Preparation

A) Films Made in Petri Dishes with 1% Wt Solids in Solution

Various soy protein film compositions are in Table 1. These are made using film solutions of different composition. Soy protein source: Soy protein Isolate with a protein content of 95%

For small applications, the films are prepared by mixing 1 g of total ingredients (soy protein isolate, glycerol, surfactant, and bitrex) with 50 ml of DI water at room temperature for 10 min. The pH of the solution is then adjusted to 9 with a NaOH solution (2 mol·L−1) under constant stirring, and then heated in a water bath to 85° C. for 30 min while stirring. The solution is then poured into a petri dish and left to dry for 2 days to form a film. The films containing Bitrex have 1000 ppm of Bitrex in the dry film (1 mg of Bitrex/g of film).
Soy protein source: Soy protein Isolate with a protein content of 95%
   Soy Protein Film Solution Compositions with 2% Wt Solids

| | | 2% wt solids | | | | |
|---|---|---|---|---|---|---|
| Soy | | Soy | | | | |
| protein | | protein | | | | DI |
| Film | glycerol:surfactant | Isolate | Glycerol | Surfactant | Bitrex | Water |
| codes | Ratio | (g) | (g) | (g) | (mg) | (g) |
| 6:4:0 | N/A | 0.60 | 0.40 | 0 | 0 | 50 |
| 6:4:0 | N/A | 0.60 | 0.40 | 0 | 1 | 50 |
| Bitrex | | | | | | |
| 6:2:2 | 1:1 | 0.60 | 0.20 | 0.20 | 0 | 50 |
| 6:2:2 | 1:1 | 0.60 | 0.20 | 0.20 | 1 | 50 |
| Bitrex | | | | | | |
| 7:2:1 | 2:1 | 0.70 | 0.20 | 0.10 | 0 | 50 |
| 7.5:2.5 | N/A | 0.75 | 0.25 | 0 | 0 | 50 |
| 7:3 | N/A | 0.70 | 0.30 | 0 | 0 | 50 |
| 7:1:2 | 1:2 | 0.70 | 0.10 | 0.20 | 0 | 50 |
| 6:3:1 | 3:1 | 0.60 | 0.30 | 0.10 | 0 | 50 |
| 6:1:3 | 1:3 | 0.60 | 0.10 | 0.30 | 0 | 50 |
| 6:0:4 | N/A | 0.60 | 0 | 0.40 | 0 | 50 |
| 7:1.5:1.5 | 1:1 | 0.70 | 0.15 | 0.15 | 0 | 50 |
| 7:2.4:0.6 | 4:1 | 0.70 | 0.24 | 0.06 | 0 | 50 |
| 7:0.6:2.4 | 1:4 | 0.70 | 0.06 | 0.24 | 0 | 50 |
| 6:3.2:0.8 | 4:1 | 0.60 | 0.32 | 0.08 | 0 | 50 |
| 6:0.8:3.2 | 1:4 | 0.60 | 0.08 | 0.32 | 0 | 50 |

B) Films Made with Casting Knife Method with Viscous Solutions with Higher % Wt Solids

For films with a greater surface area (roughly A4 size) the following method is used. Viscous solutions are made with a with higher % wt of solids, and then cast on to a polyacrylate plate with a film applicator with a casting knife set at a thickness of 700 μm.

### Soy Protein Film Preparation:

100 g of film-making solutions of different compositions (see table below) are prepared to a specified total solids concentration. The films containing Bitrex have 1000 ppm of Bitrex in the dry film (1 mg of Bitrex/g of film). The ingredients are mixed with DI water at 500 rpm and room temperature for 10 min. The pH of the solution is then adjusted to 9 with a NaOH solution (2 mol·L−1) under constant stirring, and then heated in a water bath to 85° C. for 30 min while stirring mechanically at 500 rpm. The solution is then poured into centrifuge tubes and centrifuged to remove air bubbles (air bubbles can also be removed via vacuum or ultrasound, or letting it set overnight). The films are cast onto polyacrylate plates using an automated casting machine with a casting speed of 0.02 m/s and a casting knife thickness of 700 μm onto a polyacrylate plate, dried at room temperature overnight, and peeled from the plate for testing.

Soy Protein Film Compositions with High % Wt Solids

| | | | Soy | | | | |
|---|---|---|---|---|---|---|---|
| | | | protein | | | | DI |
| Soy protein | % wt | glycerol:surfactant | Isolate | Glycerol | Surfactant | Bitrex | Water |
| Film codes | solids | Ratio | (g) | (g) | (g) | (mg) | (g) |
| 6:4:0 | 7.5 | N/A | 4.5 | 3 | 0 | 0 | 92.5 |
| 6:4:0 Bitrex | | N/A | 4.5 | 3 | 0 | 7.5 | 92.5 |
| 6:4:0 | 10 | N/A | 6 | 4 | 0 | 0 | 90 |
| 6:4:0 Bitrex | | N/A | 6 | 4 | 0 | 10 | 90 |
| 6:2:2 | 7.5 | 1:1 | 4.5 | 1.5 | 5 | 0 | 89 |
| 6:2:2 Bitrex | | 1:1 | 4.5 | 1.5 | 5 | 7.5 | 89 |
| 6:2:2 | 10 | 1:1 | 6 | 2 | 6.66 | 0 | 85.3 |
| 6:2:2 Bitrex | | 1:1 | 6 | 2 | 6.66 | 10 | 85.3 |

### 6:4 Soy Protein Films

7.5% wt solids in solution: 100 g of film solution requires: 4.5 g of SPI, 3 g of glycerol, and 92.5 g of water, which is a ratio of Soy Protein to glycerol of 6:4. The film with Bitrex contains 7.5 mg of Bitrex in 100 g of solution
10% wt solids in solution: 100 g of film solution requires: is 6 g of SPI, 4 g of glycerol, and 90 g of water, which is a ratio of Soy Protein to glycerol of 6:4. The film with Bitrex contains 10 mg of Bitrex in 100 g of solution.

### 6:2:2 Soy Protein Films

7.5% wt solids in solution: 100 g of film solution requires 4.5 g of SPI, 1.5 g of glycerol, 5 g surfactant and 89 g of water, which is a ratio of SPI to glycerol and surfactant of 6:2:2. The film with Bitrex contains 7.5 mg of Bitrex in 100 g of solution.
10 wt % solids in solution: for 100 g of film solution we have 6 g of SPI, 2 g of glycerol, g surfactant and 85.3 g of water, which is approximately a ratio of SPI to glycerol and surfactant of 6:2:2. The film with Bitrex contains 10 mg of Bitrex in 100 g of solution.

### Example 9 Method for Making the Soy Protein Film Compositions of Example 8

### Casting

1. Films are cast on to a polyacrylate substrate using a Elcometer 4340 Motorised/Automatic Film Applicator and Elcometer 3570 Micrometric Film Applicators.
2. The casting knife is set to desired thickness (for clarity this is the thickness of the cast solution or wet film, before the film has set and water evaporated from the solution).
3. The optimum casting height is 700 μm and film thicknesses were varied.
4. Casting speed 3 (1.2 m per minute) is advantageous for reducing bubbles.
5. Any bubbles observed can be popped e.g. with a sharp spatula.
6. The films are then dried in ambient laboratory conditions for 12-48 hours (the time depends on ambient conditions) and then tested for peeling from the substrate. For increased drying speed, films can be dried in an oven at 40° C. for 2 hours.

Varying amounts of surfactant can be included in the formulation depending on the surfactant content of the film. Up to 30% wt. can be included for functionality by way of surfactant included in the film. Thus, in a unit dose capsule the target surfactant level of the formulation (per unit dose) can be reached by including only 70% wt. of said target.

Soy capsules containing a substrate treatment formulation are made as per the method of Example 5.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A water-soluble film comprising a protein and a bittering agent.

2. The water-soluble film according to claim 1 wherein the bittering agent is incorporated within the water-soluble film.

3. The water-soluble film according to claim 1 wherein the bittering agent is selected from the group consisting of selected from: capsicinoids; vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Preferred bittering agents include capsaicinoids, which includes capsaicin, dihydrocapsaicin, nordihydrocapsaicin, homodihydrocapsaicin, homocapsaicin, and nonivamide.

4. The water-soluble film according to claim 1 wherein the bittering agent is a capsicinoids, preferably capsaicin.

5. The water-soluble film according to claim 1 wherein the bittering agent is selected from denatonium benzoate, denatonium saccharide, quinine or a salt of quinine.

6. The water-soluble film according to claim 1 wherein the bittering agent is denatonium benzoate.

7. The water-soluble film according to claim 1 wherein protein excludes gelatine.

8. The water-soluble film according to claim 1 wherein the protein comprises a plant protein.

9. The water-soluble film according to claim 1 wherein the protein comprises pulse protein.

10. The water-soluble film according to claim 1 further comprising a plasticizing surfactant.

11. The water-soluble film according to claim 1 wherein the protein is present from 40% wt. of the film.

12. The water-soluble film according to claim 1 comprising at least one co-plasticiser comprising a polyol, a poly glycerol or a poly alcohol.

13. (canceled)

14. A unit dose product comprising a water-soluble capsule comprising a first film comprising a thermoformed recess, said recess containing a substrate treatment composition and a second film superposed over said first film, said first and second films sealed around the edge, wherein the first film comprises a protein and a bittering agent and the second film comprises a protein and a bittering agent.

15. A method of making a unit dose product comprising:
a. adding a bittering agent to a protein
b. forming a film from a forming a unit dose product from said film.
